(19) United States
(12) Patent Application Publication
(10) Pub. No.: US 2009/0135858 A1
(43) Pub. Date: May 28, 2009

(54) LASER OSCILLATION APPARATUS AND CONTROLLING METHOD THEREOF

(75) Inventor: Yukio KYUSHO, Kokubunji-shi (JP)

Correspondence Address: FOLEY AND LARDNER LLP;SUITE 500, 3000 K STREET NW, WASHINGTON, DC, 20007, US

(73) Assignee: OMRON CORPORATION

(21) Appl. No.: 12/273,957

(22) Filed: Nov. 19, 2008

(30) Foreign Application Priority Data
Nov. 22, 2007 (JP) P2007-303761

(51) Int. Cl. H01S 3/11

(52) U.S. Cl. 372/10

(57) ABSTRACT

An aspect of the present invention provides a laser oscillation apparatus in which a control circuit can be simplified to variably control a Q switch pulse width with low cost and a controlling method thereof. A laser oscillation apparatus according to an aspect of the present invention includes a laser oscillator head, a Q switch pulse width setting circuit, an LD current control circuit, an LD driver, an RF amplitude control circuit, and an RF driver. The laser oscillator head includes an internal AOQ-SW element, and an excitation LD. The LD current control circuit and the LD driver controls a current applied to excitation LD such that the current becomes not more than a laser oscillation threshold in synchronization with timing when an optical resonator of the laser oscillator head oscillates one-time or plural-time Q switch pulse.

### BACKGROUND OF THE INVENTION

1. Technical Field

The present invention relates to a laser oscillation apparatus, particularly to a laser oscillation apparatus which can vary a Q switch pulse width and a controlling method thereof.

2. Related Art

A continuous pulse having a narrow pulse width and a high peak is stably obtained in an Acoust-Optic Q-Switch (hereinafter referred to as AOQ-SW) laser oscillation apparatus in which utilizes an ultrasonic sound to generate a Continuous Wave (hereinafter sometimes referred to as CW). Therefore, the AOQ-SW laser oscillation apparatus is widely spread in the fields such as laser trimming and laser masking.

Conventionally, in the AOQ-SW laser oscillation apparatus, there is a drawback of not freely changing a Q switch (hereinafter sometimes referred to as Q-SW) laser pulse width. For example, the Q switch pulse width is automatically fixed when an excitation LD (Laser Diode) current is kept constant at repetitive frequency of 5 kHz. Accordingly, under the condition of constant current, the Q switch pulse width cannot be lengthened or lowered.

In principle of laser, for example, the Q switch pulse width is variably controlled by the following three methods. In the first method, an excitation time of a laser medium is controlled within a fluorescent life of a laser active ion, and the excitation time is lengthened to the fluorescent life. Therefore, the peak power can be enhanced to shorten the Q switch pulse width. On the contrary, when the excitation time is shortened compared with the fluorescent life, the peak power can be decreased to lengthen the Q switch pulse width.

Q switch laser characteristics shown in FIG. 11 are utilized in the first method. FIG. 11 is a graph showing characteristics of the Q switch pulse with excitation light intensity kept constant in the case where a horizontal axis indicates the Q switch frequency while a vertical axis indicates a Q switch pulse peak output and a Q switch pulse width. As shown in FIG. 11, when the excitation light intensity is kept constant, the Q switch pulse width becomes longer as the Q switch oscillation frequency is increased, and the Q switch pulse width becomes shorter as the Q switch oscillation frequency is decreased. When the Q switch oscillation frequency is decreased, the switch pulse width tends to be saturated. For example, in the case where the Q switch pulse frequency of 1 kHz is required, the actual Q switch frequency is configured by utilizing the principle so as to be able to be oscillated in five stages of 1 kHz, 5 kHz, 10 kHz, 15 kHz, and 20 kHz. In the frequencies of at least 5 kHz, a laser pulse string is thinned out into ⅕, 1/10, 1/15, and 1/20 using an external high-speed optical shutter or the like. Therefore, the five-stage 1-kHz laser pulse string having different Q switch pulse widths can be obtained. However, as shown in FIG. 11, the Q switch pulse peak output largely depends on the Q switch oscillation frequency. Therefore, when the peak outputs are matched with one another, an external attenuator is required to attenuate the peak output. The peak output is not effectively utilized due to the attenuation, which results in a problem of a cost phase to which importance is given as an industrial laser apparatus such that the laser oscillation apparatus is enlarged.

The second method is to increase excitation light density of the excitation laser medium. Therefore, the Q switch pulse width can be shortened. That is, when the current value of the excitation LD is increased to enhance the LD output light intensity, or when the fed LD excitation light power is kept constant, the Q switch pulse width can be shortened by focusing the LD excitation light to a smaller diameter.

As shown in FIG. 12, the characteristic of shortening the Q switch pulse width with increasing LD excitation light intensity is utilized in the second method. FIG. 12 is a graph of a relationship between the LD excitation light intensity set at the horizontal axis and the Q switch pulse width set at the vertical axis. The LD excitation light intensity can be increased by increasing the LD current value. The pulse width can be selected to a certain extent by a method in which the AOQ-SW laser oscillation apparatus is used with a current value, at which the desired pulse width (designated by the letter tp in FIG. 12) is obtained, by utilizing the characteristic. However, similarly to the first method, in the case where the wide pulse width and the narrow pulse width are simultaneously used at the same peak output, it is necessary that the output is attenuated by the attenuator.

The third method is to lengthen and shorten a round-trip time in the optical resonator by stretching and shortening the optical resonator length. In principle, stretching and shortening the optical resonator length has a large effect in changing the Q switch pulse width. For example, even if the light travels back and forth in the active medium having the same gain, the round-trip time is shortened, that is, the number of round-trip times is increased by shortening the optical resonator length. Therefore, the whole of the Q switch pulse width is shortened by shortening the pulse rising time. However, because the optical resonator length is hardly changed in the actual apparatus, the third method is a difficult method from the viewpoint of external control of the pulse width.

Therefore, for example, a method disclosed in Japanese Patent Application Laid-Open No. 2001-353585 is currently used as the pulse width variably controlling method. The method disclosed in Japanese Patent Application Laid-Open No. 2001-353585 is similar to that of the continuous-wave Q switch oscillator in which the usual AOQ-SW element is used except that the turn-on and turn-off of the AOQ-SW element is controlled at a time Ta before timing of the Q switch oscillation signal. That is, an excitation accumulation time to an upper level is controlled. Thus, the generated Q switch pulse width is controlled by controlling the gain of the laser oscillation apparatus.

FIG. 13 shows a configuration of the laser oscillation apparatus in which the method disclosed in Japanese Patent Application Laid-Open No. 2001-353585 is performed. The laser oscillation apparatus of FIG. 13 includes a laser oscillation apparatus head 11, an external AOD (Acoust-Optic Deflector) element 1 14, timing circuits 101 and 102, and RF drivers 21 and 121. As shown in FIG. 13, the laser oscillation apparatus head 11 is a laser oscillation apparatus head of a side-face excitation type. The optical resonator of the laser oscillation apparatus head 11 includes a total reflection mirror 15, a Nd:YAG rod 12, an internal AOQ-SW element 14, and an outgoing mirror 16 which are sequentially disposed on an oscillator optical axis 50. An excitation LD 13 is disposed in a side face of the Nd:YAG rod 12 to irradiate a side face of the Nd:YAG rod 12 with the excitation light. Therefore, the laser oscillation apparatus disclosed in Japanese Patent Application Laid-Open No. 2001-353585 has a feature that the Q switch pulse width can be controlled based on the external signal. Specifically, the pulse width shown in a chart (7) of FIG. 14 can be shortened by shortening the accumulation time Ta to the upper level shown in a chart (2) of FIG. 14.

However, in the method disclosed in Japanese Patent Application Laid-Open No. 2001-353585, because the excitation light is continuous light, the oscillation of the CW light is generated in a region where the Q switch is turned on. Therefore, unfortunately the CW light is supplied from an outgoing port of the oscillator head. The problem will be described with reference to FIG. 14. FIG. 14 is a timing chart showing an operation in the pulse width variable control in which the laser oscillation apparatus of FIG. 13 is used. As shown in FIG. 14, an oscillator output (chart (4) of FIG. 14) corresponding to the case in which RF (Radio Frequency) power (chart (3) of FIG. 14) is not applied to the internal Q switch supplies the continuous wave in a range shown by a bold line. That is, the continuous wave oscillation is generated in the range where originally the laser beam should not be emitted. Therefore, it is necessary that a shutter be placed outside the oscillator head.

Because the method disclosed in Japanese Patent Application Laid-Open No. 2001-353585 is applied to a laser trimming apparatus, it is necessary that the external optical switch be a high-speed switch. Therefore, the oscillation portion of the CW component is cut off using an AOD element having high switching speed. As shown in a chart (5) of FIG. 14, an RF power control signal 154 supplied to the external AOD element is turned on until the pulse oscillation of the chart (4) of FIG. 14 is ended. Then the RF power control signal 154 supplied to the external AOD element is turned off in a period of the continuous wave oscillation shown in the chart (4) of FIG. 14. As shown in the parts (5) and (6) of FIG. 14, RF power 155 supplied to the external AOD element is turned off to turn on the external Q switch, and the RF power 155 supplied to the external AOD element is turned on to turn off the external Q switch. The CW component is cut off by turning off the external Q switch, and only the pulse component is supplied from an external AOD element 114 as shown in a chart (7) of FIG. 14. The beam of the CW component shown in a chart (8) of FIG. 14 is diffracted by the external AOD element 114, and the beam impinges on an absorption block, thereby preventing the beam from impinging on a forming surface. Then, as shown in the chart (5) of FIG. 14, the external Q switch is turned on at timing in which the internal Q switch is turned off.

Therefore, in the method disclosed in Japanese Patent Application Laid-Open No. 2001-353585, it is necessary to use two sets of AO (Acoust-Optic) elements, that is, the AOQ-SW element inside the optical resonator and the AOD element outside the optical resonator. Similarly to the AOQ-SW element, because the RF driver circuit is required in the AOD element, unfortunately not only the control is complicated, but also cost is increased. Because a radiation noise is generated in the RF driver circuit due to a nature of the RF driver circuit, sometimes a configuration which reduces the radiation noise is required from the viewpoint of specifications of the apparatus, which also results in the problem of the cost increase.

In view of the foregoing, an object of the present invention is to provide a laser oscillation apparatus in which the control circuit can be simplified to variably control the Q switch pulse width with low cost and a controlling method thereof.

### SUMMARY

A laser oscillation apparatus according to an aspect of the present invention includes an optical resonator which includes a solid-state laser medium and a Q switch element on an optical axis thereof, the solid-state laser medium serving to perform laser oscillation and the Q switch element serving to perform Q switch pulse oscillation; an excitation light source which irradiates the solid-state laser medium with excitation light to enable the laser oscillation; and an excitation light control unit which decreases intensity of the excitation light to predetermined intensity in synchronization with timing when the optical resonator performs the Q switch pulse oscillation one time or a plurality of times, the predetermined intensity being lower than a threshold of the laser oscillation.

A method for controlling a laser oscillation apparatus according to another aspect of the present invention includes the steps of synchronizing to a timing when the optical resonator performs Q switch pulse oscillation one time or a plurality of times; and decreasing intensity of the excitation light to predetermined intensity, the solid-state laser medium being irradiated with the excitation light at the synchronized timing, the predetermined intensity being lower than a threshold of the laser oscillation of the optical resonator.

Accordingly, because the Q switch pulse which does not include the continuous wave component is obtained with no use of the external element except for the Q switch element incorporated in the laser oscillation apparatus, the present invention can provide the laser oscillation apparatus in which the control circuit is simplified to variably control the Q switch pulse width with low cost.

### BRIEF DESCRIPTION OF THE DRAWINGS

FIG. 1 shows a block diagram of a configuration of a laser oscillation apparatus according to a first embodiment of the present invention;

FIG. 2 shows a timing chart of an operation in a Q switch pulse width controlling method in which the laser oscillation apparatus of FIG. 1 is used;

FIG. 3 shows a block diagram of a configuration of an LD current control circuit;

FIG. 4 shows a timing chart of a pulse width Pw of an LD current;

FIG. 5 shows a block diagram of a configuration of a laser oscillation apparatus according to a second embodiment of the present invention;

FIG. 6 shows a timing chart of an operation in a Q switch pulse width controlling method in which the laser oscillation apparatus of FIG. 5 is used;

FIG. 7 shows a block diagram of a configuration of a laser oscillation apparatus according to a third embodiment of the present invention;

FIG. 8 shows a timing chart of an operation in a Q switch pulse width controlling method in which the laser oscillation apparatus of FIG. 7 is used;

FIG. 9 shows a block diagram of a configuration of a laser oscillation apparatus according to a fourth embodiment of the present invention;

FIG. 10 shows a timing chart of an operation in a Q switch pulse width controlling method in which the laser oscillation apparatus of FIG. 9 is used;

FIG. 11 shows a graph of Q switch pulse characteristics with excitation light intensity kept constant in the case where a horizontal axis indicates a Q switch frequency while a vertical axis indicates a Q switch pulse peak output and a Q switch pulse width;

FIG. 12 shows a graph of a relationship between LD excitation light intensity set at the horizontal axis and the Q switch pulse width set at the vertical axis;

FIG. 13 shows a block diagram of a configuration of a laser oscillation apparatus disclosed in Japanese Patent Application laid-Open No. 2001-353585 in which a pulse width variable method is performed; and

FIG. 14 shows a timing chart of an operation in a Q switch pulse width controlling method in which the laser oscillation apparatus of FIG. 13 is used.

### DETAILED DESCRIPTION

The present invention has the following features. The laser oscillation apparatus according to an aspect of the present invention performs control such that a current applied to an excitation light source is lowered to a predetermined current value lower than a laser oscillation threshold of an optical resonator in synchronization with timing when the optical resonator performs Q switch pulse oscillation. Therefore, in the AOQ-SW laser oscillation apparatus which can emit the CW light, the Q switch pulse which does not include the CW component can be obtained without adding an external element.

At this point, a surface of a solid-state laser medium may be irradiated with the excitation light, the surface being orthogonal to the optical axis of the optical resonator or a surface of the solid-state laser medium may be irradiated with the excitation light, the surface being located along the optical axis of the optical resonator.

The control may be performed such that the current applied to the excitation light source is decreased to the predetermined current value for a time longer than a rising time of a Q switch pulse in synchronization with timing of the Q switch pulse oscillation of one time or a plurality of times, the predetermined current value being lower than a current value of the threshold of the laser oscillation.

An optical shutter which may further be disposed between the excitation light source and the laser medium, and the excitation light control unit opens and closes the optical shutter to control the intensity of the excitation light.

The excitation light source may be a laser diode.

The excitation light source may include plural laser diodes, and the excitation light control unit controls the intensity of the excitation light by changing the number of laser diodes which emit light.

The excitation light control unit may control the intensity of the excitation light such that the intensity of the excitation light is greater than the threshold of the laser oscillation in synchronization with a period when the Q switch element is operated to lower a Q value of the optical resonator.

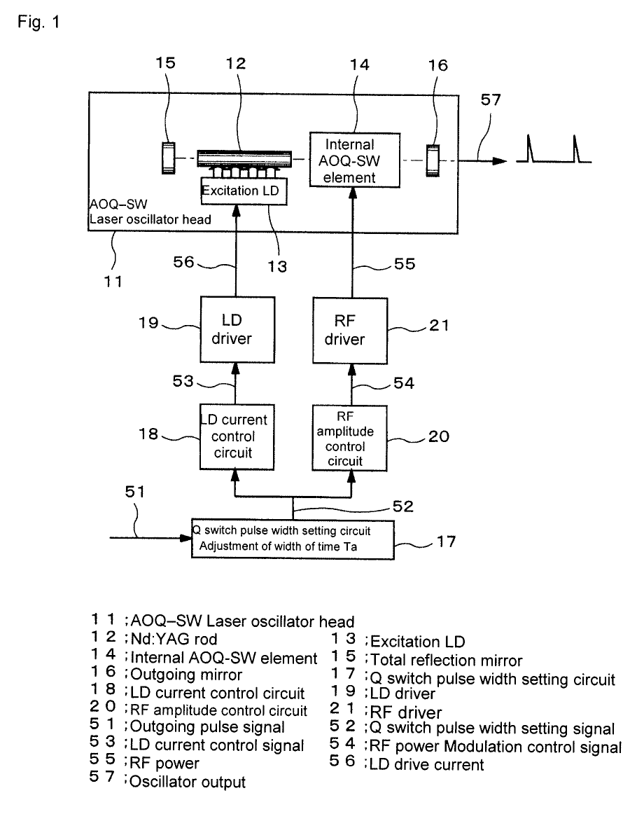

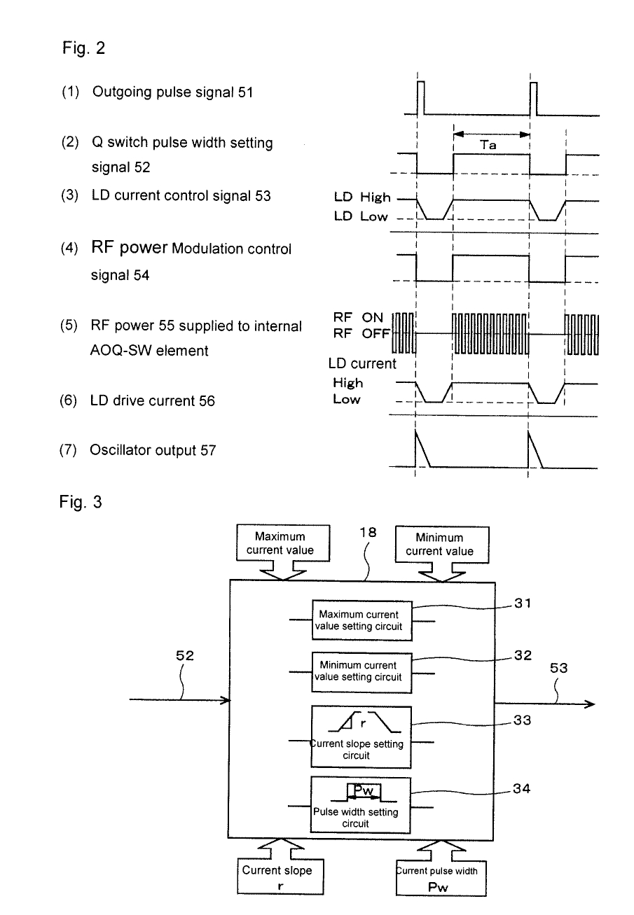

Preferred embodiments of the present invention will be described with reference to the accompanying drawings. A first embodiment of the present invention will be described first. FIG. 1 shows a block diagram of a configuration of a laser oscillation apparatus according to a first embodiment of the present invention, and FIG. 2 shows a timing chart of an operation in a Q switch pulse width controlling method in which the laser oscillation apparatus of FIG. 1 is used.

Referring to FIG. 1, the laser oscillation apparatus of the first embodiment includes a laser oscillator head 11, a Q switch pulse width setting circuit 17, an LD current control circuit 18, an LD driver 19, an RF amplitude control circuit 20, and an RF driver 21.

The laser oscillator head 11 is a laser oscillator head of a side-face excitation type. An optical resonator of the laser oscillator head 11 includes a total reflection mirror 15, a Nd:YAG rod 12, an internal AOQ-SW element 14, and an outgoing mirror 16 which are sequentially disposed on an oscillator optical axis 50. An excitation LD 13 is disposed to irradiate a side face of the Nd:YAG rod 12 with excitation light. The outgoing mirror 16 which is located on the laser beam outgoing side and the total reflection mirror 15 which is located on the side opposite to the outgoing mirror 16 are disposed so as to face each other. The internal AOQ-SW element 14 can switch a Q value of the optical resonator between a high value and a low value. The excitation LD 13 is disposed so as to be able to irradiate a surface (side face) along an optical axis direction of the Nd:YAG rod 12 with the excitation light. The irradiation of the excitation light enables the optical resonator to perform the laser oscillation of the continuous wave.

The operation of the first embodiment will be described with reference to FIGS. 1 and 2. As shown in FIG. 1, the Q switch pulse width setting circuit 17 sets a Q switch pulse width based on an outgoing pulse signal 51 (chart (1) of FIG. 2) fed from the outside. The Q switch pulse width setting circuit 17 supplies a Q switch pulse width setting signal 52 (chart (2) of FIG. 2) to the LD current control circuit 18 located on the side of the excitation LD 13 and the RF amplitude control circuit 20 located on the side of the internal AOQ-SW element 14. A time Ta in the chart (2) of FIG. 2 is a time in which energy necessary to generate a pulse having the desired Q switch pulse width is accumulated in a laser upper level. In the first embodiment, the control is performed such that the time Ta is kept constant in each of the plural-time pulse oscillation.

The LD current control circuit 18 controls a current (LD current) for driving the excitation LD 13 based on the Q switch pulse width setting signal 52 fed from the Q switch pulse width setting circuit 17. That is, the LD current control circuit 18 controls the drive current of the excitation LD 13 in synchronization with a period when RF power is turned off to adjust the accumulation time (Ta). The LD current control circuit 18 supplies a LD current control signal 53 (chart (3) of FIG. 2) to the LD driver 19. As shown in the chart (3) of FIG. 2, in the LD current control signal 53 of the first embodiment, a High level and a Low level are switched to each other in a slope manner, that is, the High level and the Low level are changed so as to have a signal level slope with respect to a time axis. In the first embodiment, as mentioned below, the Low level shown in the chart (3) of FIG. 2 is set higher than a level (LD 0) corresponding to the case in which a LD drive current 56 is zero.

The LD driver 19 supplies the LD drive current 56 (chart (6) of FIG. 2) to the excitation LD 13 based on the LD current control signal 53 fed from the LD current control circuit 18. Similarly to the LD current control signal 53, in the LD drive current 56, the High level and the Low level of the LD current are switched to each other in the slope manner as shown in the chart (6) of FIG. 2. The High level of the LD drive current 56 corresponds to a High level (LD High) shown in the chart (3) of FIG. 2. In the High level, the LD drive current 56 is greater than a laser oscillation threshold. In the first embodiment, the Low level of the LD drive current 56 is greater than zero and slightly lower than the laser oscillation threshold. The excitation LD 13 is driven to excite the side face of the Nd:YAG rod 12 by the fed LD drive current 56, thereby causing the Nd:YAG rod 12 to oscillate the laser beam.

The RF amplitude control circuit 20 sets an amplitude of the RF power supplied to the internal AOQ-SW element 14 based on the Q switch pulse width setting signal 52 fed from the Q switch pulse width setting circuit 17. The RF amplitude control circuit 20 performs the control so as to turn on the RF power in order that the Q value of the optical resonator is set at the low value only for the time (Ta) set by the Q switch pulse width setting circuit 17. Then the RF amplitude control circuit 20 supplies a modulation control signal 54 (chart (4) of FIG. 2) of the RF power corresponding to the amplitude of the set RF power to the RF driver 21. As shown in the chart (4) of FIG. 2, the modulation control signal 54 of the RF power has an waveform whose High and Low levels are switched in synchronization with the Q switch pulse width setting signal 52. In the first embodiment, the Q value of the optical resonator becomes the low value when the RF power is turned on, and the Q value of the optical resonator becomes the high value when the RF power is turned off.

The RF driver 21 supplies RF power 55 (chart (5) of FIG. 2) modulated by the internal AOQ-SW element 14 based on the modulation control signal 54 of the RF power fed from the RF amplitude control circuit 20. As shown in the chart (5) of FIG. 2, the RF power 55 is tuned on and off at timing synchronized with the modulation control signal 54 of the RF power. When the RF power is turned on (during the time Ta of the chart (2)), the RF power 55 are supplied to the internal AOQ-SW element 14 in the form of the RF power of the waveform having the set amplitude and the predetermined frequency. In the chart (5) of FIG. 2, the RF waveform is illustrated in the simplified form (the same holds true in the following drawings).

The internal AOQ-SW element 14 rapidly sets the Q value of the optical resonator at the high value when the RF power 55 fed from the RF driver 21 is turned off. Therefore, the laser oscillation apparatus of the first embodiment supplies an oscillator output 57 (chart (7) of FIG. 2) which is of the Q switch pulse having the pulse width corresponding to the time Ta. In the oscillator output 57 shown in the chart (7) of FIG. 2, neither a pulse component nor a CW component are supplied in a horizontal portion indicated by zero except for the projected pulse waveform (the same holds true in the following drawings).

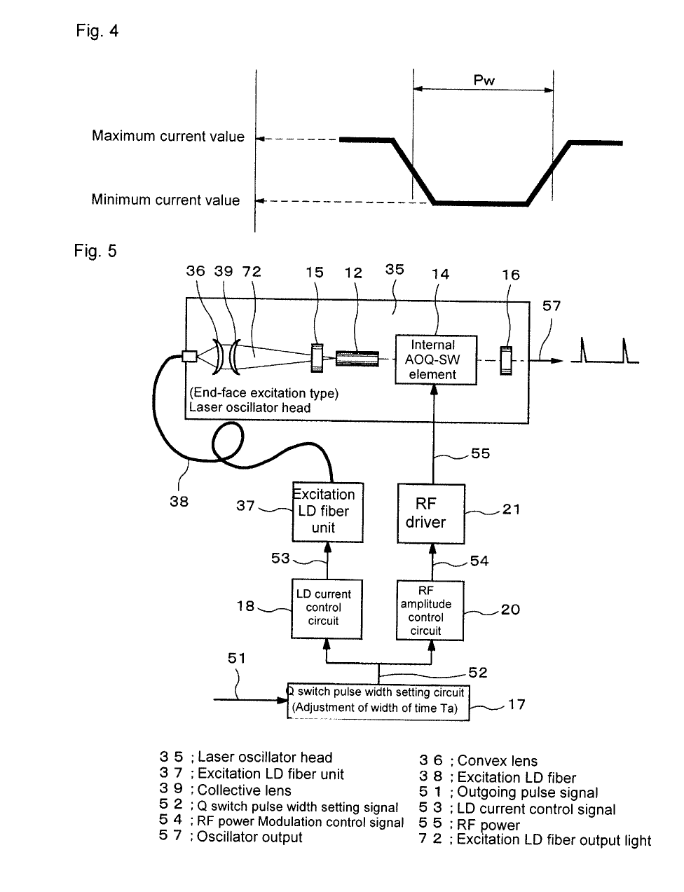

The LD current control circuit 18 will be described in detail with reference to FIGS. 3 and 4. FIG. 3 is a block diagram showing a configuration of the LD current control circuit 18, and FIG. 4 shows a timing chart of a pulse width Pw of the LD current. Referring to FIG. 3, the LD current control circuit 18 includes a maximum current value setting circuit 31, a minimum current value setting circuit 32, a current slope setting circuit 33, and a pulse width setting circuit 34. Input parameters (maximum current value, minimum current value, current slope r, and current pulse width Pw) except for the Q switch pulse width setting signal 52 are imparted to the LD current control circuit 18 from the outside.

The LD current control circuit 18 of the first embodiment has a function that can control the LD current value while setting the High and Low levels and a function that imparts the slope to the change in current when the LD current value is switched between the High and Low levels. As described above, in the first embodiment, the value set at the Low level of the LD current is slightly lower than the laser oscillation threshold. Accordingly, in the laser oscillation apparatus of the first embodiment, even if only one AO element is used, the CW laser beam can be caused not to be supplied in turning off the RF power 55 supplied to the internal AOQ-SW element 14, that is, in setting the Q value of the optical resonator at the high value.

The reason why the slope is imparted to the change in LD current value is that sometimes a heat quantity generated by the LD element is largely changed to promote deterioration of the LD element when the LD current value is turned on and off while the LD current value has a large temporal change (=ΔId/Δt) in the case of the high-power LD. Therefore, in the first embodiment, the slope is imparted to the change in LD current value to suppress the ΔId/Δt to a small level, whereby the control is performed such that the deterioration is suppressed as much as possible. Preferably the time necessary to change the current value in the slope shape is lengthened as much as possible in order to suppress the deterioration of the LD element. However, in the case where the LD current value is greater than the threshold after rising and falling of the Q switch pulse, the CW component is supplied until the LD current value becomes lower than the threshold. Actually, because an influence on the output light is little when the time in which the CW component is supplied, the time necessary to change the current value in the slope shape can be fixed in consideration of this point.

As described above, in the first embodiment, the excitation LD is not driven by the constant current value, but the control is performed such that the LD drive current 56 becomes the threshold of the current value of the optical resonator or less in synchronization with the time in which the RF power 55 applied to the internal AOQ-SW element 14 is turned off. Therefore, unlike the conventional technique, the CW laser power component which is generated along with the Q switch pulse in the conventional technique can be eliminated without providing the external AOD element outside the resonator. This means that remarkable cost reduction can be realized because one AOD element and a set of RF drivers for driving the AOD element are neglected.

A control circuit provided with CPU (Central Processing Unit) which controls the AOQ-SW element and the AOD element is required in the case of the use of the external AOD element. On the other hand, in the first embodiment, the system can be simplified because the control can be performed by usual logic and analog circuits. This effect becomes particularly remarkable in the case where the laser oscillation apparatus of the first embodiment is not mounted on a system such as the laser trimming apparatus, but the laser oscillation apparatus is used alone.

In the first embodiment, LD deterioration caused by a thermal strain due to rapid heat generation and cooling can be prevented by performing the control in which the slope is imparted to the LD current value in turning on and off the LD current value. At this point, the LD current value is not completely turned off, but the LD current value is lowered for a predetermined time to the predetermined current value which is not more than the threshold, which allows an average drive current of the excitation LD to be lowered by about tens percent with the gentle slope. Therefore, a life of the excitation LD can largely be lengthened compared with the conventional technique. The effect becomes particularly remarkable in HD having the high power more than tens watts.

In the first embodiment, the time in which the energy is accumulated in the upper level is controlled at a constant value. Therefore, a so-called first pulse in which the initial Q switch pulse is increased several times subsequent pulses in turning on and off the laser can automatically be suppressed.

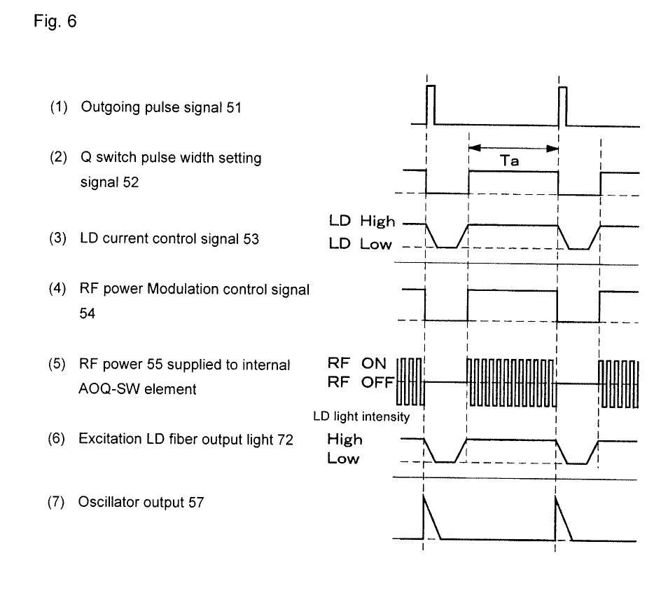

A second embodiment of the present invention will be described with reference to FIGS. 5 and 6. FIG. 5 is a block diagram showing a configuration of a laser oscillation apparatus of the second embodiment, and FIG. 6 shows a timing chart of an operation in a Q switch pulse width controlling method in which the laser oscillation apparatus of FIG. 5 is used. In FIGS. 5 and 6, the same component as the first embodiment of FIGS. 1 to 4 is designated by the same numeral, and the detailed description is neglected.

The laser oscillation apparatus of the second embodiment differs from that of the first embodiment in an end-face excitation type LD excitation laser in which a surface (end face) orthogonal to the optical axis direction of the optical resonator in the Nd:YAG rod is irradiated with the excitation light to excite the Nd:YAG rod. An excitation LD in which the excitation light is supplied from an end portion of an optical fiber is used in the second embodiment.

Referring to FIG. 5, the laser oscillation apparatus of the second embodiment has an end-face excitation type laser oscillator head 35. The laser oscillation apparatus of the second embodiment includes an excitation LD fiber unit 37 and an excitation LD fiber 38 instead of the LD driver 19 and excitation LD 13 of FIG. 1. A fiber with a pigtail can be used as the excitation LD fiber 38.

The laser oscillator head 35 is an end-face excitation type head. Similarly to the first embodiment, an optical resonator of the laser oscillator head 35 includes the total reflection mirror 15, the Nd:YAG rod 12, the internal AOQ-SW element 14, and the outgoing mirror 16 which are sequentially disposed on the oscillator optical axis 50. An optical fiber 38 is irradiated at an end face of the Nd:YAG rod 12 to irradiate the Nd:YAG rod 12 with the excitation light. In the second embodiment, an output end of the optical fiber 38 is attached to the end face of the Nd:YAG rod 12 in order to irradiate the Nd:YAG rod 12 through the total reflection mirror 15 with excitation LD fiber output light 72. A convex lens 36 and a collective lens 39 are provided between the output end of the optical fiber 38 and the total reflection mirror 15. The convex lens 36 is used to form the excitation LD fiber output light 72 into parallel light, and the collective lens 39 is used to collect the light onto the end face of the Nd:YAG rod 12. Additional optical system such as a lens may be provided.

The operation of the second embodiment will be described below while focusing on a point different from that of the first embodiment. In the second embodiment, the LD current control signal 53 which is of the signal from the LD current control circuit 18 is fed into an excitation LD fiber unit 37. In the first embodiment, the LD driver 19 of FIG. 1 supplies the LD drive current 56 to the excitation LD 13, and the LD drive current 56 has the waveform which is switched between the High and Low levels with the slope-shape change. On the other hand, in the second embodiment, the excitation LD fiber unit 37 irradiates the end face of the Nd:YAG rod 12 through the optical fiber 38 with the excitation LD fiber output light 72. Similarly to the LD drive current 56 (chart (6) of FIG. 2) of the first embodiment, as shown in the chart (6) of FIG. 6, the excitation LD fiber output light 72 is light having an intensity level which is switched between High and Low levels with the slope-shape change. The High level of the excitation LD fiber output light 72 corresponds to a High level (LD High) shown in a chart (3) of FIG. 6. In the High level, the excitation LD fiber output light 72 has the light intensity which is greater than the laser oscillation threshold. The Low level of the excitation LD fiber output light 72 corresponds to a Low level (LD Low) shown in the chart (3) of FIG. 6. In the second embodiment, the light intensity of the Low level is greater than zero and slightly lower than the laser oscillation threshold. The light excites the Nd:YAG rod 12 to cause the optical resonator to perform the laser oscillation. The control circuit located on the side of the internal AOQ-SW element 14 and the parts (1) to (5) and (7) of FIG. 6 are similar to those of the first embodiment.

Thus, in the second embodiment, the effect similar to that of the first embodiment can be obtained using the end-face excitation type laser oscillator head.

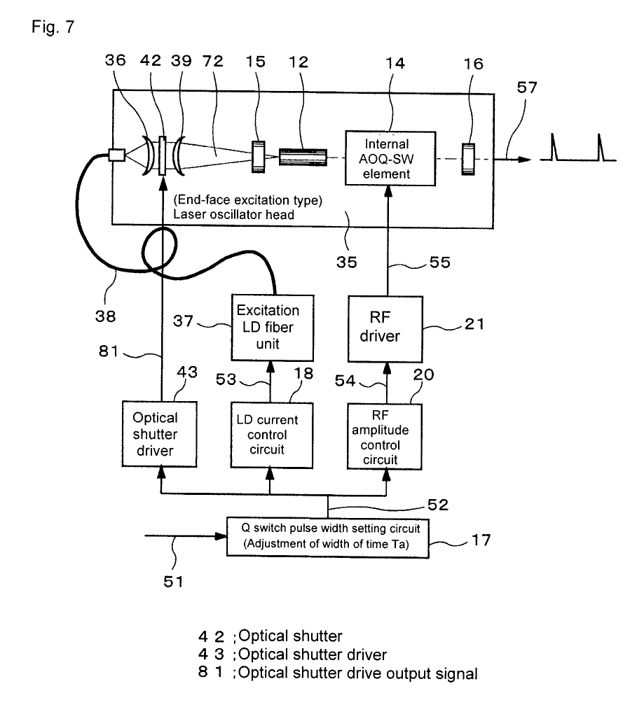

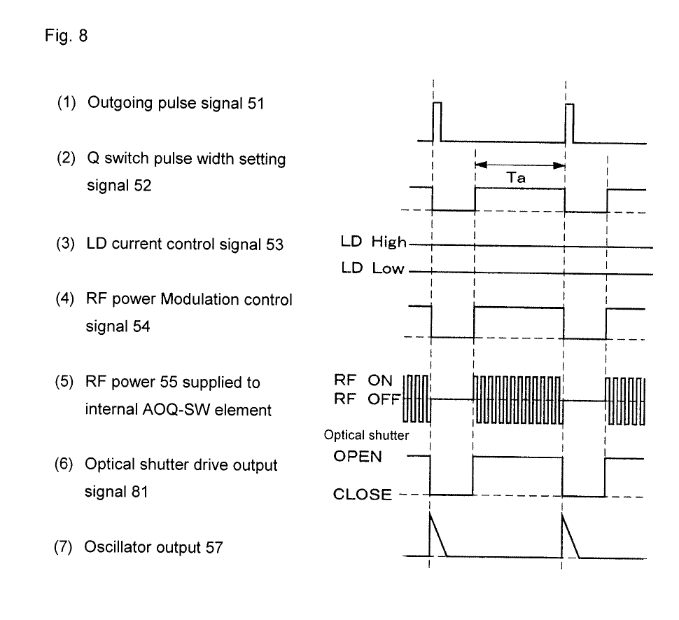

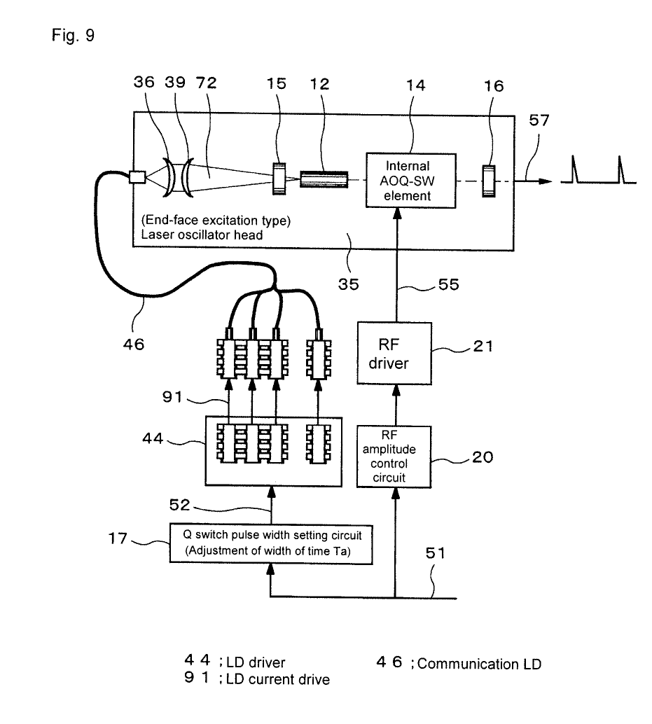

A third embodiment of the present invention will be described with reference to FIGS. 7 and 9. FIG. 7 is a block diagram showing a configuration of a laser oscillation apparatus of the third embodiment, and FIG. 8 shows a timing chart of an operation in a Q switch pulse width controlling method in which the laser oscillation apparatus of FIG. 7 is used. In FIGS. 7 and 8, the same component as the first and second embodiments of FIGS. 1 to 6 is designated by the same numeral, and the detailed description is neglected.

Similarly to the second embodiment, the laser oscillation apparatus of the third embodiment is an end-face excitation type laser oscillator. However, the laser oscillation apparatus of the third embodiment differs from that of the second embodiment in that the laser oscillation apparatus of the third embodiment includes an optical shutter 42 which cuts off the excitation LD fiber output light 72 and an optical shutter driver 43. As shown in FIG. 7, the optical shutter 42 can be provided between the convex lens 36 and the collective lens 39.

The operation of the third embodiment will be described below while focusing on a point different from that of the second embodiment. In the second embodiment, the LD current control signal 53 is the signal having the waveform which is switched between the High and Low levels with the slope-shape change. In the third embodiment, the LD current control signal 53 is supplied at a constant level (High level) from the LD current control circuit 18. Therefore, the excitation LD fiber unit 37 and the excitation LD fiber 38 irradiate the end face of the Nd:YAG rod 12 with the constant-intensity excitation LD fiber output light 72.

In the third embodiment, the level of the excitation LD fiber output light 72 is controlled by opening and closing the optical shutter 42 at high speed. Therefore, the Q switch pulse width setting signal 52 which is of the signal from the Q switch pulse width setting circuit 17 is fed into the optical shutter driver 43. The optical shutter driver 43 supplies an optical shutter drive output signal 81 (chart (6) of FIG. 8) to the optical shutter 42 based on the fed Q switch pulse width setting signal 52. The optical shutter 42 is opened and closed based on the fed optical shutter drive output signal 81, thereby turning on and off the excitation LD fiber output light 72 with which the end face of the Nd:YAG rod 12 is irradiated.

In the operation of the third embodiment, the optical shutter 42 mechanically cuts off the excitation LD fiber output light 72. Accordingly, the optical shutter drive output signal 81 is not controlled in the slope-shape change shown in the chart (6) of FIG. 6, but the optical shutter drive output signal 81 is controlled such that the optical shutter 42 is opened and closed at timing of the Q switch pulse width setting signal 52 as shown in the chart (6) of FIG. 8. In the third embodiment, the optical shutter 42 is closed at timing of the pulse oscillation. Therefore, because the CW component is not generated, only the pulse component is supplied as shown in a chart (7) of FIG. 8. Then the optical shutter 42 is switched so as to be opened in synchronization with the Q switch pulse width setting signal 52 (in the beginning of the time Ta).

In the third embodiment, the excitation LD is turned on and off without modulating the output light of the excitation LD. Therefore, a life of the large-power excitation LD can be lengthened, although the life of the large-power excitation LD is possibly shortened when the excitation LD is frequently turned on and off. Examples of the optical shutter 42 include a rotary slit which is of a low-cost optical shutter, a shutter in which a Polymer Dispersed Liquid Crystal (PDLC) is utilized, a shutter translucent ceramic PLZT (Pb_{1-y}La_{y}ZrₓTi₁₋ₓO₃).

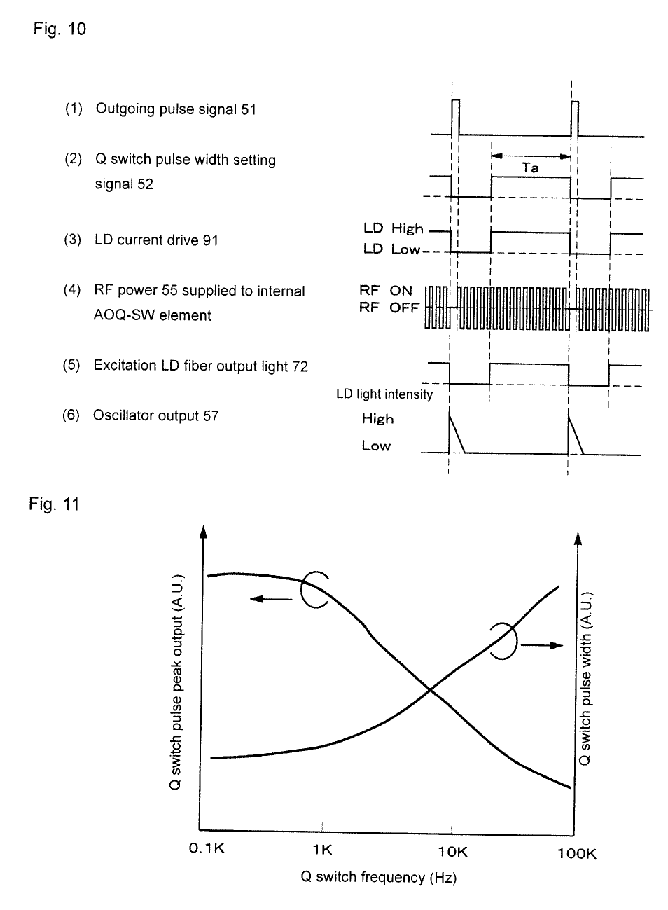

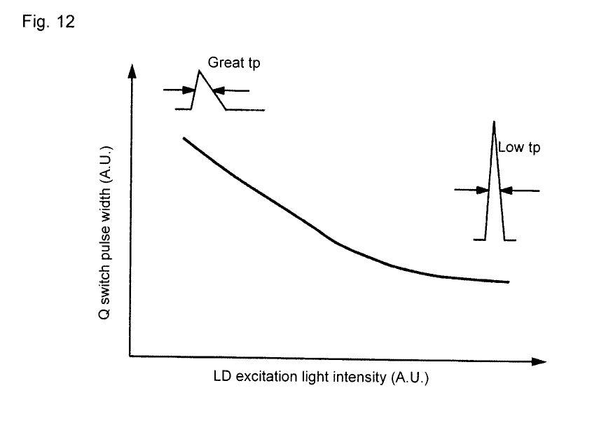

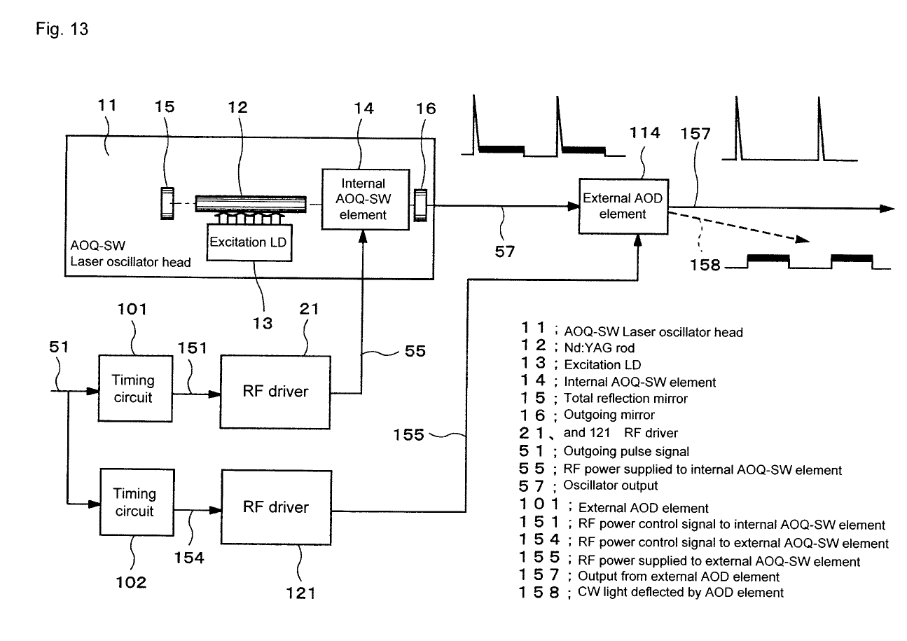

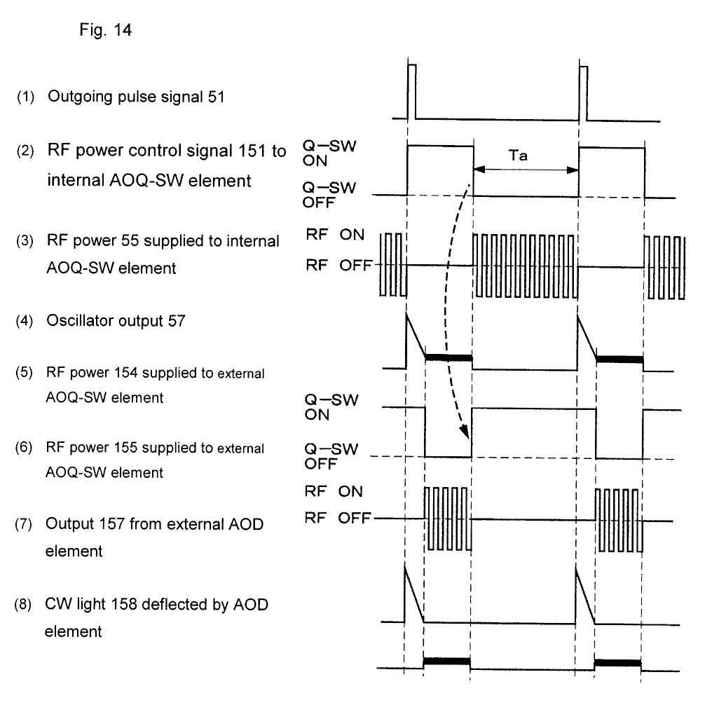

A fourth embodiment of the present invention will be described with reference to FIGS. 9 and 10. FIG. 9 is a block diagram showing a configuration of a laser oscillation apparatus of the fourth embodiment, and FIG. 10 shows a timing chart of an operation in a Q switch pulse width controlling method in which the laser oscillation apparatus of FIG. 9 is used. In FIGS. 9 and 10, the same component as the first to third embodiments of FIGS. 1 to 8 is designated by the same numeral, and the detailed description is neglected.

Similarly to the second embodiment, the laser oscillation apparatus of the fourth embodiment is an end-face excitation type laser oscillator. However, the laser oscillation apparatus of the fourth embodiment differs from that of the second embodiment in the following configuration. That is, in the fourth embodiment, an LD driver 44 and a communication LD 46 are provided instead of the LD current control circuit 18 and excitation LD fiber 38 of FIG. 5. The communication LD 46 is formed by bundling plural communication LDs. In the fourth embodiment, the signal is not fed into the RF amplitude control circuit 20 from the Q switch pulse width setting circuit 17, but the outgoing pulse signal 51 is fed into the RF amplitude control circuit 20.

The operation of the fourth embodiment will be described below while focusing on a point difference from that of the second embodiment. The LD driver 44 supplies an LD current drive 91 (chart (3) of FIG. 10) to the communication LD 46 based on the Q switch pulse width setting signal 52 fed from the Q switch pulse width setting circuit 17. At this point, because the communication LD 46 is a high-reliability fiber output type LD, the modulation can be performed to the communication LD 46 at significantly high speed. Therefore, in the fourth embodiment, the control is performed such that the LD current drive 91 does not have the slope-shape waveform, but the LD current drive 91 has a step-like waveform at timing synchronized with the Q switch pulse width setting signal 52 (chart (2) of FIG. 10). The communication LD 46 irradiates the end face of the Nd:YAG rod 12 with the excitation LD fiber output light 72 based on the fed LD current drive 91. At this point, the intensity level of the excitation LD fiber output light 72 is controlled by adjusting the number of bundled plural communication LDs which emit the light. In the fourth embodiment, as shown in a chart (5) of FIG. 10, the excitation LD fiber output light 72 has the step-like intensity level like the LD current drive 91 shown in the chart (3) of FIG. 10. Alternatively, similarly to the first and second embodiments, the intensity level of the excitation LD fiber output light 72 may be controlled with the slope-shape change by controlling the number of communication LDs which emit the light. In the fourth embodiment, because the intensity level of the excitation LD fiber output light 72 is controlled by the number of communication LDs which emit the light, the Low level (parts (3) and (5) of FIG. 10) may be slightly lower than the laser oscillation threshold, or the Low level may be set at zero like the first embodiment.

The RF amplitude control circuit 20 supplies the RF power modulation control signal 54 to the RF driver 21 based on the fed outgoing pulse signal 51. The RF driver 21 supplies the RF power 55 modulated by the internal AOQ-SW element 14 based on the fed RF power modulation control signal 54. As shown in a chart (4) of FIG. 10, the RF power 55 of the fourth embodiment differs from that of the second embodiment in that the turn-on and turn-off of the RF power 55 are controlled at timing synchronized with a chart (1) of FIG. 10. At this point, the RF power 55 applied to the internal AOQ-SW element 14 is always turned on except that the RF power 55 is turned off for a predetermined time (for example, 10 μs) at timing in which the Q switch pulse is supplied. Therefore, the need for simultaneously controlling the current of the excitation LD and the RF power is eliminated, so that the control can be simplified.

Currently the communication LD 46 of the fourth embodiment has the output of hundreds milli-watts. In the case where the industrial laser oscillation apparatus has the output of several watts to ten watts, it is necessary that the excitation LD have the output at least about double the industrial laser oscillation apparatus, that is, about 5 w to about 20 W. Accordingly, in order to apply the communication LD 46 to the excitation LD, it is necessary that the communication LD 46 is used while plural LDs are bundled. However, in consideration of the reliability that the communication LD 46 can be used for at least 100000 hours without trouble, advantageously the communication LD 46 of the fourth embodiment is used as the excitation light source for the industrial laser. Sometimes the communication LD 46 may be formed by one LD according to the relationship between the output of the single LD and the output of the laser oscillation apparatus.

The present invention can suitably be applied to a laser trimming apparatus for a thin-film trimmer and a chip resistor trimmer, a ceramic scriber, a glass cutter, a via-hole making machine for multi-layer substrate, a laser wafer marker, a laser marking apparatus for metal, a laser marking apparatus for resin package, a re-crystallization (annealing) apparatus for solar-cell amorphous Si, and a thin-film cutting apparatus for Cu and Au.

What is claimed is:

1. A laser oscillation apparatus comprising:
an optical resonator which includes a solid-state laser medium and a Q switch element on an optical axis thereof, the solid-state laser medium serving to perform laser oscillation and the Q switch element serving to perform Q switch pulse oscillation;
an excitation light source which irradiates the solid-state laser medium with excitation light to enable the laser oscillation; and
an excitation light control unit which decreases intensity of the excitation light to predetermined intensity in synchronization with a timing when the optical resonator performs the Q switch pulse oscillation one time or a plurality of times, the predetermined intensity being lower than a threshold of the laser oscillation.

2. The laser oscillation apparatus according to claim 1, wherein a surface of the solid-state laser medium is irradiated with the excitation light, the surface being orthogonal to the optical axis of the optical resonator.

3. The laser oscillation apparatus according to claim 1, wherein a surface of the solid-state laser medium is irradiated with the excitation light, the surface being located along the optical axis of the optical resonator.

4. The laser oscillation apparatus according to claim 1, wherein the excitation light control unit includes a current control unit, the current control unit decreasing a current applied to the excitation light source to a predetermined current value for a time longer than a rising time of a Q switch pulse in synchronization with a timing of the Q switch pulse oscillation of one time or a plurality of times, the predetermined current value being lower than a current value of the threshold of the laser oscillation.

5. The laser oscillation apparatus according to claim 1, further comprising an optical shutter which is disposed between the excitation light source and the laser medium
wherein the excitation light control unit opens and closes the optical shutter to control the intensity of the excitation light.

6. The laser oscillation apparatus according to claim 1, wherein the excitation light source is a laser diode.

7. The laser oscillation apparatus according to claim 1, wherein the excitation light source includes a plurality of laser diodes, and
the excitation light control unit controls the intensity of the excitation light by changing the number of laser diodes which emit light.

8. The laser oscillation apparatus according to claim 1, wherein the excitation light control unit controls the intensity of the excitation light such that the intensity of the excitation light is greater than the threshold of the laser oscillation in synchronization with a period when the Q switch element is operated to lower a Q value of the optical resonator.

9. A method for controlling a laser oscillation apparatus, the laser oscillation apparatus including an optical resonator which includes a solid-state laser medium and a Q switch element on an optical axis thereof, the solid-state laser medium serving to perform laser oscillation and the Q switch element serving to perform Q switch pulse oscillation; and an excitation light source which irradiates the solid-state laser medium with excitation light to enable the laser oscillation, the method for controlling the laser oscillation apparatus comprising the steps of:
synchronizing with a timing when the optical resonator performs Q switch pulse oscillation one time or a plurality of times; and
decreasing intensity of the excitation light to predetermined intensity at the synchronized timing, the predetermined intensity being lower than a threshold of the laser oscillation of the optical resonator.

10. The method for controlling the laser oscillation apparatus according to claim 9, wherein the intensity of the excitation light is controlled by decreasing a current applied to the excitation light source to a predetermined current value for a time longer than a rising time of a Q switch pulse, the predetermined current value being lower than a current value of the threshold of the laser oscillation.
